(19) United States
(12) Patent Application Publication
(10) Pub. No.: US 2007/0016899 A1
(43) Pub. Date: Jan. 18, 2007

(54) Technique for the calling of a sub-routine by a function using an intermediate sub-routine

(76) Inventors: Dineel D. Sule, Stafford, TX (US); Eric J. Stotzer, Houston, TX (US)

Correspondence Address: TEXAS INSTRUMENTS INCORPORATED, P O BOX 655474, M/S 3999, DALLAS, TX, 75265, US

(21) Appl. No.: 11/473,768

(22) Filed: Jun. 23, 2006

Related U.S. Application Data
(60) Provisional application No. 60/699,988, filed on Jul. 14, 2005.

(51) Int. Cl. G06F 9/44

(52) U.S. Cl. 717/162; 717/166

(57) ABSTRACT

In order to call a sub-routine, a software program first calls an intermediate or stub sub-routine. The stub sub-routine is provided with the address of the sub-routine and the return address. The stub sub-routine saves the states of the selected system resources and calls the sub-routine. After executing the sub-routine, the process returns to the stub sub-routine where the states of the resources, previously saved, are restored. The stub sub-routine returns the process to the return address. By up-dating the stub sub-routine, existing programs can be made backward compatible without the need for revising the software program. When the stub sub-routine is used with a plurality of software programs, the total code length can be reduced by placing the state-saving function only in the stub sub-routine.

This application claims the benefit of Provisional Application Serial No. 60/699,988, entitled “Function Calling Convention Customization Optimized for Code Size”, filed on Jul. 15, 2005.

### BACKGROUND OF THE INVENTION

1. Field of the Invention

This invention relates generally to the execution of software programs and, more particularly to the procedure for calling a subroutine for use by a software program.

2. Background of the Invention

As chip architectures evolve, newer architectures might add new machine resources or even make more efficient usage of a certain subset of existing machine resources. Since the resource might not have existed at the time of the original design or might not have been a primary focus area during the original design of the original “calling convention” the best possible usage of such resources might not be represented. This problem is particularly pertinent in the case where existing resources are more efficiently being used by newer evolutions of the original architectures. Identifying a mechanism to make better usage efficiently of such machine resources by defining an updated calling convention without breaking the original “calling convention” is the problem addressed by this invention.

The primary existing solution to this problem today is to define a brand new calling convention for a newer architecture. However, such a definition breaks the existing calling convention and so software code compiled for earlier architectures is incompatible with the code compiled for the newer architecture.

Referring to FIG. 1, an example of the technique for calling a sub-routine is illustrated. The executing software program saves the state of selected resources in step 11. In step 12, the executing software program calls the sub-routine needed to continue the processing of the program. In step 13, the called sub-routine is executed. The sub-routine returns the control of the processor from the sub-routine to the executing program in step ′14. In step 15, the executing software program restores the saved state and resumes the software program execution.

The activity of saving the state of a processing unit resource typically includes saving the contents of a register to memory. Then, after completion of the sub-routine and the return to the software program, the values in the register are restored by transferring the contents saved in memory to the appropriate register. Note that each software program must include code for the saving the resources. Thus each program has a certain amount of duplicated code.

Another solution to this problem has been to save and restore resources “contaminated” during the function call in the body of the calling function itself. But this method is not generally “efficient” in terms of the size of the body of the calling function.

A need has therefore been felt for apparatus and an associated method having the feature of providing an in improved technique for the calling of a sub-routine by a software program. It would be another feature of the apparatus and associated method to provide a calling technique that permits backward compatibility with calling techniques for previous architectures. It would be a further feature of the apparatus and associated method to reduce the code length of the calling requirements of a plurality of software programs. It would be a still further feature of the apparatus and associated method to provide an intermediate sub-routine which incorporates the calling convention compatible for a plurality of software programs.

Our solution proposes that we save/restore/transform required machine resources in a single, shared, central location.

### SUMMARY OF THE INVENTION

The foregoing and other features are accomplished, according the present invention, by calling a sub-routine by means of an intermediate sub routine, herein after referred to as a stub sub-routine. The stub sub-routine includes all of the calling conventions with respect to resource availability. By using a stub sub-routine, a plurality of software programs that require the sub-routine can be provided with the sub-routine without the need to provide the code in each program. Furthermore, the stub sub-routine can maintain a backward-compatibility with previous program versions.

Other features and advantages of present invention will be more clearly understood upon reading of the following description and the accompanying drawings and the claims.

### BRIEF DESCRIPTION OF THE DRAWINGS

FIG. 1 is an example of the technique for calling a sub-routine accordi9ng to the prior art.

FIG. 2 illustrates the process for calling a sub-routine according to the present invention.

### 1. DETAILED DESCRIPTION OF THE FIGURES

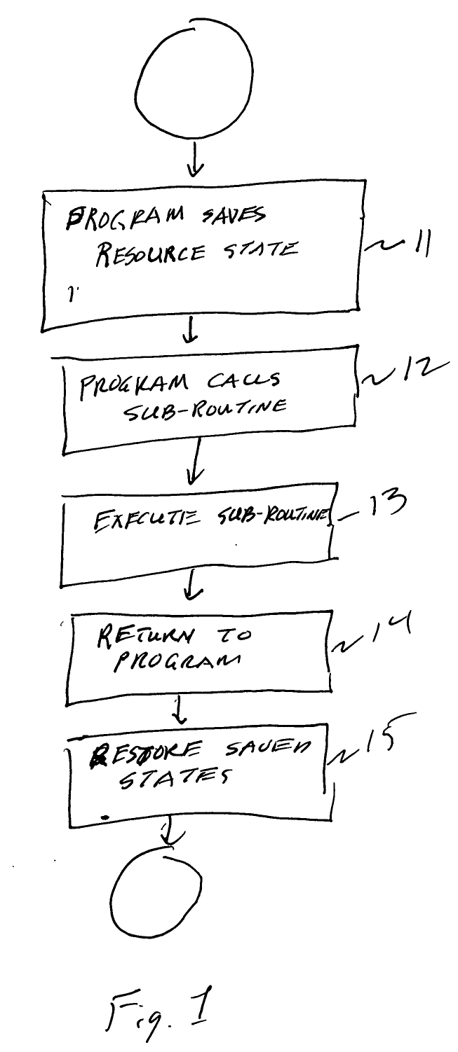

FIG. 1 has been described with respect to the related art.

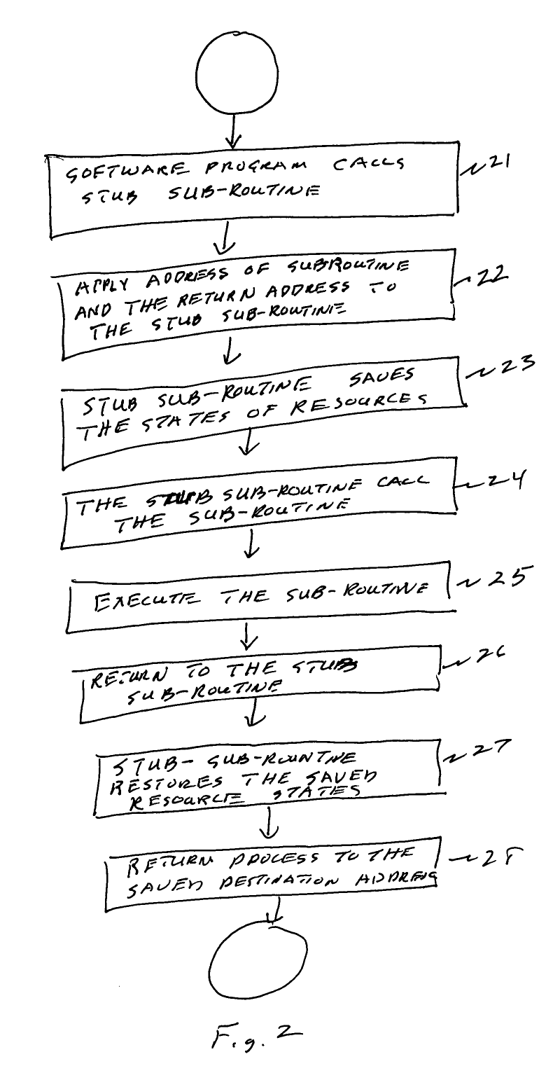

Referring to FIG. 2, the technique for calling and executing a sub-routine by a software program according to the present invention is shown. In step 21, the executing software program calls a stub sub-routine. The executing software program then provides the stub sub-routine with the address of the sub-routine to be executed and the address to which to return after the execution of the sub-routine in step 22. In step 23, the stub sub-routine saves the states of the resources. In step 24, the stub sub-routine calls the sub-routine. The called sub-routine is then executed in step 25. In step 26, after the execution of the sub-routine, the process returns to the stub routine. In step 26, the stub subroutine restores the resource states that were saved in step 23. In step 27, the processor control is returned to the software program associated with the destination address that had been stored in the stub sub-routine in step 22.

### 2. Operation of the Preferred Embodiment

The present invention involves generating a central, shared piece of code (i.e., the stub sub-routine) where certain activity can be performed before actually transferring to the desired lower level function or the sub-routine. The called stub sub-routine receives as input the address of the lower level function and the address to which the process must return after the execution of the sub-routine.

The call stub then implements mechanisms to save the existing state of certain machine resources before jumping to the lower level function, restore the saved state after completion of the lower level function, and shifting the contents of some resources around.

All of the foregoing activity is performed such that a pre-defined, legacy “convention” can be honored when we enter the called function. In other words, the use of the stub sub-routine permits the calling of the sub-routine to be backward compatible.

The calling function then provides the input required by the central, shared call stub sub-routine and jumps to the call stub instead of the lower level function. The calling function is also aware of the fact that it is calling the stub sub-routine so can now follow the more efficient and appropriate calling convention for the duration of its execution.

A function or software program calling a sub-routine to perform a certain task very often has a specific convention/contract about usage of machine resources by the lower level function. Things defined by the convention include, but are not limited to, some of the following:

preservation of convention in certain machine resources, and

passage of expected input to the lower level function.

In the foregoing discussion, the generic term resources has been used. As will be clear to those skilled in the art, the term resources most frequently refers to registers. As the architecture of a processing unit changes, the registers can be relabeled and/or the characteristics, such as register length can be changed. The present invention permits these changes to be accommodated in the stub sub-routine and not in the calling program.

While the invention has been described with respect to the embodiments set forth above, the invention is not necessarily limited to these embodiments. Accordingly, other embodiments, variations, and improvements not described herein are not necessarily excluded from the scope of the invention, the scope of the invention being defined by the following claims.

What is claimed is:

1. A method for calling a sub-routine by a processing function, the method comprising:
calling a stub sub-routine;
supplying the sub-routine address and return address to the stub sub-routine;
saving the existing states of the machine resources by the stub sub-routine;
executing the sub-routine; and
restoring the saved states after execution of the sub-routine.

2. The method as recited in claim 1 wherein the restoring is performed by the stub sub-routine.

3. The method as recited in claim 2 further comprising returning to the processing junction at the return address after restoring the saved states.

4. The method as recited in claim 1 wherein the resources include registers.

5. The method as recited in claim 5 wherein the contents of registers are stored in machine memory by the stub sub-routine.

6. The method as recited in claim 1 wherein the stub sub-routine can be called by a plurality of processing functions.

7. The method as recited in claim 1 further comprising achieving backward-compatibility by the processing functions with revised machine architectures with the stub sub-routine.

8. The method as recited in claim 1 further comprising reducing the total code length of a plurality of processing functions by implementing the state saving procedures in the stub sub-routine.

9. An operation of a stub sub-routine, the operation comprising;
responding to call by a software program by storing a sub-routine address, a return address;
saving the states of selected processing unit resources;
calling the sub-routine;
returning to the stub sub routine after execution of the sub-routine;
restoring the states of the selected processing unit resources; and
returning to the software program at the return address.

10. The operation as recited in claim 7 wherein saving includes saving the contents of selected registers in processing unit memory.

11. The operation as recited in claim 9 wherein the stub sub-routine can be called by a plurality of software programs.

12. The operation as recited in claim 9 wherein implementing the saving the states in the stub sub-routine reduces the total code length of the plurality of software programs are reduced

13. The operation as recited in claim 9 wherein implementing the saving the states in the stub sub-function permits the calling software program to be backward compatible with new processing unit architectures.

14. The operation as recited in claim 9 further comprising implementing the processing system resources with registers.

15. The operation as recited in claim 14 further comprising saving the state of processing unit registers in processing unit memory.
